(19) United States
(12) Patent Application Publication
(10) Pub. No.: US 2010/0024265 A1
(43) Pub. Date: Feb. 4, 2010

(54) Stationary Surface, For Example a Playing Field, and Method for Providing Signs on a Stationary Surface

(76) Inventor: Franz Ulrich, Wilen b. Wollerau (CH)

Correspondence Address: BRIAN ROFFE, ESQ, 540-B WILLOW AVENUE, CEDARHURST, NY, 11516-2211, US

(21) Appl. No.: 12/301,829

(22) PCT Filed: May 22, 2007
(86) PCT No.: PCT/EP2007/004519

§ 371 Date: Jul. 1, 2009

(30) Foreign Application Priority Data
May 24, 2006 (CH) 00851/06

(51) Int. Cl. G09F 19/22; B05D 1/02

(52) U.S. Cl. 40/584; 427/427.3; 427/140

(57) ABSTRACT

A stationary surface, for example a playing field (1) for a sports occasion, can be provided with signs (5, 5′) distributed approximately uniformly in rows or in accordance with a certain pattern. Optimum use of the surface for providing special advertising etc. can be obtained as a result.

The invention relates to a stationary surface, for example a playing field in accordance with the preamble of claim 1 together with a method for the application of signs to a stationary surface.

It is known that playing fields are provided not only with marked lines but also with other signs such as, for example, advertising logos.

The object of the present invention to make use in an optimal manner of a stationary surface for an event—for example, a playing field used for a sporting event—for the purpose of advertising or the like, where in addition a method is also to be proposed for the application in accordance with the invention of advertising texts, advertising logos and advertising messages and/or structural elements to the stationary surface.

This object is resolved in accordance with the invention by a stationary surface having the characteristics of claim 1 together with a method in accordance with claim 7.

Further preferred developments of the stationary surface in accordance with the invention form the subject matter of the dependent claims.

By arranging that in accordance with the invention the total surface or the total playing field can be provided with structured signs, preferably distributed uniformly in rows or in a particular pattern, optimal utilisation of the surface for the application of advertising matter can be achieved.

In this way and in accordance with the invention, the structure of the arrangement of the signs is selected in a particularly suitable format so that from a distance the picture offers the spectators a uniform surface structure and they only see the advertising message when they are close to it.

In a special development, the individual signs are so arranged that when viewed from a greater distance they are not individually recognisable but appear as points or patches in a large-scale grid pattern which forms an advertising text, an advertising logo, an advertising message or a structural element.

In a further special development, the object formed by this large-scale grid pattern can not be seen as individual components when viewed from a distance but once again only as a constituent part of a still larger-scale grid pattern. In theory, this effect can be repeated at will. This kind of structure formation makes it possible to apply advertising matter to objects which when seen from every possible distance always permits one advertising message to be seen.

In one special development, the application of the advertising matter takes place with a reduced contrast strength so that for the spectators who are primarily interested in the proceedings and not the advertising activity, the advertising matter is not of an irritating nature and, therefore, not too intrusive. Either in isolation or in combination with the previously illustrated signs, the dimensions of the individual signs can be selected to be so small that as far as the spectators are concerned the signs are only 15 perceivable by a camera, this being dependent upon the resolution of the image transmission system and the visual acuity of the spectator so that they are effective as advertising but do not interfere with the viewer of the event in hand. Particularly in the case of sporting events in stadiums it is possible for the whole of the area of the stationary surface (e.g. a football-, rugby- or cricket pitch) to be retained.

In the case of playing fields with pitch markings, signs or advertising logos distributed in rows it is advantageous to use a lower contrast strength compared with the pitch markings. In an optimally balanced development, irritation resulting from the impression gained by both spectators who are primarily interested in the event itself and the players that the advertising matter is intrusive can be reduced or completely eliminated.

The application of advertising texts, advertising logos, advertising messages or structural elements to a stationary surface, which can be, for example, a playing field, surfaces on a flying field, surfaces on or around a race track or indeed surfaces of road used for cycle racing are preferably produced in accordance with the invention by a vehicle provided with a marking head or several nozzles each of which needs to be controlled individually depending upon the position of the vehicle and on the signs. When printing is taking place, the mobile vehicle is moved along the surface to be printed while its position is constantly determined by a satellite-navigation system. The control of the nozzles is co-ordinated by reference to the position as determined by the positioning system.

The invention can be used for a wide range of applications so in the case of stationary surfaces it can deal with playing fields either with or without surrounding surfaces, flying fields, areas on or around a race track, road surfaces, parking areas, snow fields or ice surfaces. These areas can be provided with advertising texts, advertising logos, advertising messages and or structural elements. They are particularly suitable for sporting events but also for other occasions or large scale events, especially when these are associated with media reporting facilities.

The invention is now further explained in detail by reference to the drawings as follows:

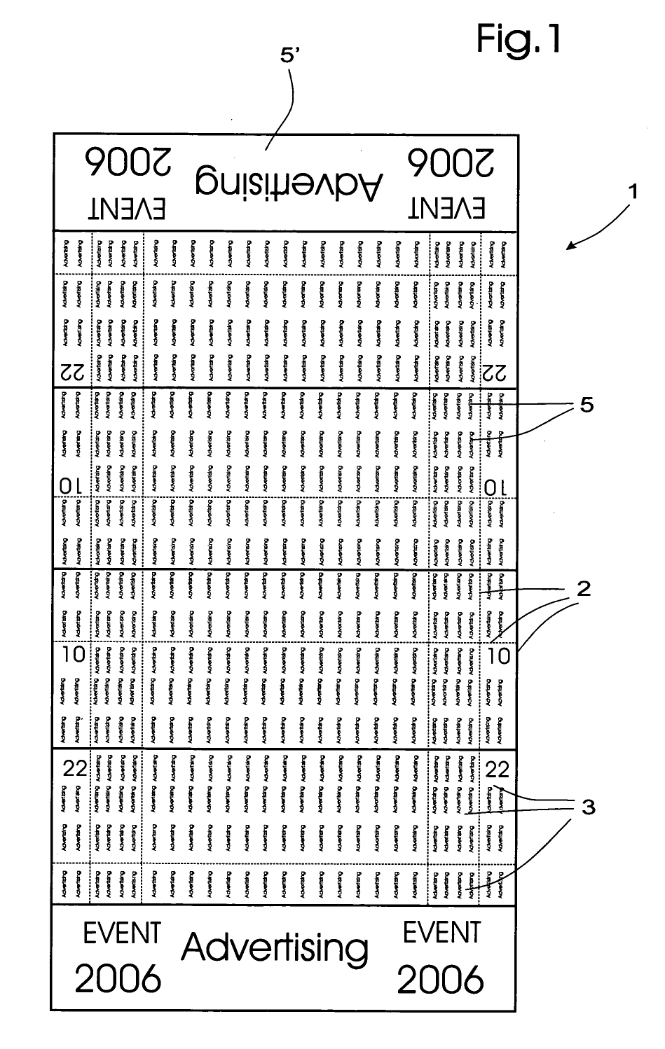

FIG. 1 shows an embodiment example of stationary surface in accordance with the invention for a sporting occasion.

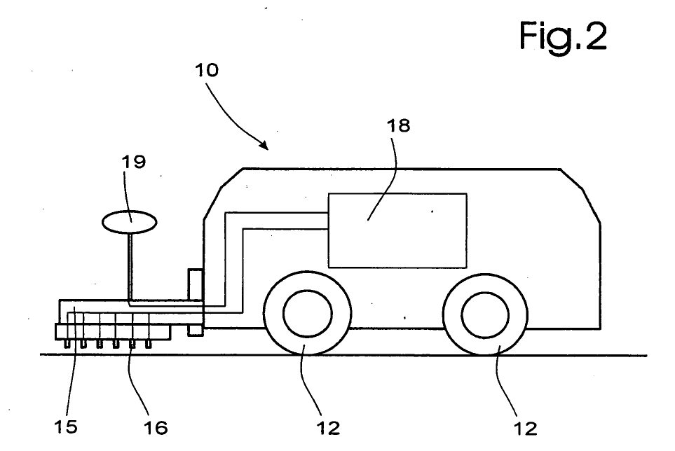

FIG. 2 is a schematic representation of the side view of a vehicle for printing the stationary surface.

FIG. 1 shows a rugby pitch as an embodiment example of a stationary surface for a sporting event in accordance with the invention. Naturally it could also be a different type of pitch, for example, a football pitch or a race track or a selected site on a road used for a cycle race.

The playing field 1 is provided with pitch markings 2 which divide the whole surface into a number of sub-sections 3.

In accordance with the invention, the whole surface of the playing field 1 is printed with rows of individual signs 5, 5′ which are used for advertising purposes and which usually consist of advertising logos. The sub-sections of the field 3 produced by the marked lines are preferably filled with the signs 5, 5′ in such a manner that the dimensions and number of the signs 5, 5′ are appropriate to the dimensions of each sub-section 3.

The dimensions and the contrast strength of the applied advertising text, advertising logos, advertising messages and / or structural elements can be so selected that the signs 5, 5′ are only recognisable by close-up photographs taken by a camera. In the case illustrated, the contrast strength of the pitch markings 2 is materially stronger than that of the applied printed matter because the pitch markings 2 must always be clearly recognisable. On the other hand, the advertising logos should not irritate spectators watching a TV screen or the players on the field.

To print the playing field 1 a vehicle 10 is used which is shown in simplified form in FIG. 2. The vehicle 10 which can move on wheels 12 is fitted with a marking head 15 which carries several nozzles (spray nozzles) 16. Each of the spray nozzles 16 is connected to an ink tank. These are arranged in one or more rows. The number of rows arranged at right-angles to the direction of travel depends upon whether one-, two- or several colours is/are required. Preferably, it is possible to vary the height of the marking head.

Electronic control features are integrated into the vehicle 10 and these can be used to activate the nozzles 16 in dependence upon the current position of the vehicle with respect to the image to be reproduced. The vehicle 10 is driven along the surface to be printed and its position is constantly monitored by a positioning system 19, preferably a satellite navigation system. The precise spatial co-ordinates of each individual nozzle 16 are determined by the positioning system. The control of the nozzles 16 is effected by co-ordination with the system identifying their precise position. The software compares the co-ordinates of the individual nozzles with specified nominal values of the individual pixels of the logo and each individual nozzle 16 is opened when it coincides with the nominal position of the pixel determined geographically.

It is possible for the vehicle (10) to reprint any damaged surfaces during pauses in the sporting event.

In this way it is possible in a problem-free manner for the signs and especially advertising logos to be applied in rows over the total surface or over the total playing field and, indeed, for them to be renewed.

It is conceivable that, for example, the surface in front of the goalposts or the penalty surface of a playing field should not be printed with the result that only the greater part the total playing field is printed.

Naturally, in accordance with the invention it is also possible to produce the effect of colour mixing or even all other kinds of optical effects such as three-dimensional printing.

Instead of the physical application of the signs it is also possible in principle to produce virtual representation during the reporting activity by the use of suitable computer programmes. A viewer then sees the signs on a TV screen in a virtual manner which corresponds to the previously described form of presentation.

1. A stationary surface, for example, a playing field for a sporting occasion, which is provided with signs (5, 5′) preferably, advertising logos characterised in that the stationary surface, for example, the playing field (1) is provided with approximately uniformly distributed signs (5, 5′) either in rows or according to a specified pattern.

2. Stationary surface in accordance with claim 1, characterised in that approximately the total stationary surface, for example, the playing field (1) is provided with signs applied either in rows or according to a specified pattern.

3. Stationary surface according to claim 1, characterised in that the stationary surface is a playing field with or without surrounding surfaces, a road surface, a parking surface, a snowfield, an ice surface, an surface on or around a flying field, or on or around a race track, each of which is provided with advertising texts, advertising logos advertising messages, pictures and/or structural elements.

4. Stationary surface in accordance with claim 1, characterised in that the contrast strength and/or the dimensions of the printed matter are so selected that the individual signs (5, 5′) are only recognisable by close-up photographs taken by a camera dependent upon the resolution of the picture transfer system and the visual acuity of the viewer.

5. Stationary surface in accordance with claim 4, characterised in that the individual signs (5, 5′) are so arranged that each of them appears as a point or a patch in a superimposed grid pattern.

6. Stationary surface in accordance with claim 4, characterised in that the contrast strength of the marked lines, especially the pitch markings (2) is greater than the contrast strength of the applied signs (5, 5′).

7. Stationary surface in accordance with claim 6, characterised in that the sub-section fields (3) delineated by the marked lines (2) are uniformly filled with the signs (5, 5′), such that the dimensions and the number of signs (5, 5′) per sub-section field (3) are suitable for the dimensions of that sub-section field.

8. Method for applying signs on to the stationary surface in accordance with claim, characterised in that the application is effected by a vehicle (10) which is fitted with a marking head (15) which has several nozzles (16), each of which can be controlled in dependence upon the position of the vehicle (10) and which correspondingly apply the signs (5, 5′) such that during the application and, in particular, the spraying activity this vehicle (10) is moved along the surface with its position being constantly monitored by a positioning system (19), preferably a satellite navigation system and with the control of the nozzles (16) resulting from co-ordination with the actual position as determined by the positioning system (19).

9. Method in accordance with claim 8, characterised in that the application of the signs by the vehicle (10) is effected, in particular, during pauses in the sporting activity in order to repair any damaged signs.

10. Method in accordance with claim 8, characterised in that the application of the signs to the stationary surface is effected before or after a main event or in pauses in that event in order to provide a spectator attraction.
